(19) United States
(12) Patent Application Publication
(10) Pub. No.: US 2014/0167550 A1
(43) Pub. Date: Jun. 19, 2014

(54) MOTOR ROTOR AND MOTOR HAVING SAME

(71) Applicants: Hui Huang, Zhuhai (CN); Yusheng Hu, Zhuhai (CN); Dongsuo Chen, Zhuhai (CN); Huajie Chen, Zhuhai (CN); Yong Xiao, Zhuhai (CN); Xueying Zeng, Zhuhai (CN); Wenming Zhang, Zhuhai (CN)

(72) Inventors: Hui Huang, Zhuhai (CN); Yusheng Hu, Zhuhai (CN); Dongsuo Chen, Zhuhai (CN); Huajie Chen, Zhuhai (CN); Yong Xiao, Zhuhai (CN); Xueying Zeng, Zhuhai (CN); Wenming Zhang, Zhuhai (CN)

(73) Assignees: GREE GREEN REFRIGERATION TECHNOLOGY CENTER CO., LTD. OF ZHUHAI, Zhuhai, Guangdong (CN); GREE ELECTRIC APPLIANCES, INC. OF ZHUHAI, Zhuhai, Guangdong (CN)

(21) Appl. No.: 14/235,611

(22) PCT Filed: Aug. 29, 2011
(86) PCT No.: PCT/CN2011/079064

§ 371 Date: Jan. 28, 2014

(30) Foreign Application Priority Data
Aug. 5, 2011 (CN) 201110224882.6

(51) Int. Cl. H02K 1/27

(52) U.S. Cl. CPC H02K 1/2766
USPC 310/156.19

(57) ABSTRACT

Disclosed are a motor rotor and a motor having same, wherein the motor rotor comprises an iron core (10) and permanent magnets (20) provided within the iron core (10), sets of mounting grooves (30) are provided in the peripheral direction of the iron core, with each set of mounting grooves comprising more than two mounting grooves (30) arranged intermittently in the radial direction of the iron core (10). The permanent magnets (20) are correspondingly embedded into the individual mounting grooves (30). The thickness of the permanent magnet (20) at the centre of the cross section thereof and perpendicular to the rotor axis is greater than the thickness at both ends thereof. The rotor optimizes the shape of the permanent magnets (20) and improves the efficiency of the motor.

### TECHNICAL FIELD

The present application relates to the field of motors, and particularly to a motor rotor and a motor having the same.

### BACKGROUND

An interior permanent magnet synchronous motor (IPM) is a motor having a layer of permanent magnet placed inside a rotor and primarily utilizing permanent magnet torque and utilizing auxiliary reluctance torque.

Resultant formula of the reluctance torque and the permanent magnet torque is as follows: T=mp(L_{q}−L_{d})i_{d}i_{q}−mpΨ_{PM}i_{q}.

Wherein, T is an output torque of a motor, the performance of the motor can be improved by increasing the value of T; the first item in the equation following T is the reluctance torque, and the second item is the permanent magnet torque; Ψ_{PM} is the maximum value of stator-rotor coupling magnetic flux generated by a permanent magnet of the motor, m is a phase number of a conductor of a stator, P is the number of pole pairs of the motor, L_{d} and L_{q} are inductances along axis d and axis q respectively, wherein axis d refers to an axis coincided with an axis of the main magnetic pole, and axis q refers to an axis perpendicular to the axis of the main magnetic pole, the perpendicular relationship refers to perpendicularity of electrical angles, and i_{d} and i_{q} are components of an armature current in the directions of axis d and axis q respectively. As can be seen from the above resultant formula, the output torque of the motor T can be increased by increasing both the permanent magnet torque as the second item and a difference of the inductances along axis d and axis q of the motor.

In prior art, the performance of the motor is generally improved by improving the performance of the permanent magnet, that is, by increasing the permanent magnet torque to increase the value of the resultant torque so as to improve the efficiency of the motor, and the common method is to use rare-earth permanent magnets. However, since rare earth is a non-renewable resource and is expensive, the widespread use of this kind of motor is restricted. However, an irreversible demagnetization of the permanent magnet may be caused by using the permanent magnet of non-rare-earth material.

In addition, due to the limited volume of the rotor and the utilization of the reluctance torque, the occupation ratio of the permanent magnets in each pole of the rotor has a limit value, which also limits the improvement of the motor efficiency.

### SUMMARY

The present application provides a motor rotor which can improve an occupation ratio of a permanent magnet by optimizing a shape of the permanent magnet so as to improve the performance of the motor rotor, and the present application further provides a motor having the motor rotor.

According to an aspect of the present application, a motor rotor is provided, which includes an iron core and a permanent magnet arranged inside the iron core, wherein a plurality of groups of mounting grooves are arranged in the iron core along a circumferential direction of the iron core, and each group of mounting grooves includes two or more than two mounting grooves arranged at intervals in a radial direction of the iron core; a plurality of groups of permanent magnets are provided, and permanent magnets in each group of permanent magnets are correspondingly embedded into corresponding mounting grooves in each group of mounting grooves; and on a cross section, in a direction perpendicular to an axis of the rotor, of each permanent magnet, a center portion of the permanent magnet has a thickness greater than two ends of the permanent magnet.

Further, a thickness of the permanent magnet in a direction along its symmetric line is T, and a thickness of the furthest end of the permanent magnet is A, and wherein,

$$\frac{2}{5} \leq \frac{A}{T} \leq 1.$$

Further, a magnetic shielding bridge is formed between an edge of each mounting groove and a periphery of the rotor, and a width of the magnetic shielding bridge is ranged from 0.5 mm to 1.0 mm.

Further, a cross section, perpendicular to an axial direction of the iron core, of each mounting groove includes an outer arc segment, and a center of the outer arc segment of the mounting groove are distributed in a symmetry axis of the rotor.

Further, the cross section, perpendicular to the axial direction of the iron core, of the mounting groove further includes an inner arc segment, and a center of the inner arc segment of the mounting groove are distributed in the symmetry axis of the rotor.

Further, the cross section, perpendicular to the axial direction of the iron core, of the mounting groove further includes a first outer straight line segment and a second outer straight line segment which are respectively connected to two ends of the outer arc segment, and an angle β is formed between the first outer straight line segment and the second outer straight line segment, and the angle β satisfies a relational expression of

$$\frac{3 π}{P} > β > \frac{4 π}{3 P} ,$$

wherein P is a number of rotor poles of the motor rotor.

Further, the cross section, perpendicular to the axial direction of the iron core, of the mounting groove further includes a first outer straight line segment connected to an end of the outer arc segment, and a first inner straight line segment connected to an end of the inner arc segment and positioned at the same side as the first outer straight line segment, and an angle α is formed between the first outer straight line segment and the first inner straight line segment, wherein a is an acute angle.

Further, a cross section, perpendicular to the axial direction of the iron core, of each of the mounting grooves includes an arc segment, and centers of arc segments, distributed sequentially in a direction from an axes to a periphery of the iron core, of each group of mounting grooves are also distributed sequentially in this direction.

Further, clearances are provided between two ends of the permanent magnet and two ends of the mounting groove in which the permanent magnet is embedded.

Further, the clearances between the two ends of the permanent magnet and the two ends of the mounting groove are filled with non-magnetically permeable media.

According to an aspect of the present application, a motor is further provided, which includes the motor rotor described above.

In the motor rotor and the motor having the same provided by the present application, the shape of the permanent magnet is optimized. On a cross section, in a direction perpendicular to an axis of the rotor, of the permanent magnet, a center portion of the permanent magnet has a thickness greater than two ends of the permanent magnet, thus more permanent magnets can be arranged in the rotor with a constant area, thereby increasing an occupation ratio of the permanent magnets in each pole of the rotor, and improving the efficiency of the motor.

### BRIEF DESCRIPTION OF THE DRAWINGS

The accompanying drawings constituting a part of the present application are provided to help further understanding the present application, and the illustrative embodiments and the description thereof are used to interpret the present application and do not constitute inappropriate limitations to the present application.

FIG. 1 is a schematic view showing the structure of a motor rotor according to the present application;

FIG. 2 is a schematic view showing a shape of a mounting groove of the motor rotor according to the present application;

FIG. 3 is a schematic view showing a thickness of a permanent magnet of the motor rotor according to the present application;

FIG. 4 is a schematic view showing the relationship between a demagnetization current and a value of A/T of the motor rotor according to the present application, in which, A is a thickness of a tail end of the permanent magnet, and T is a thickness of a center of the permanent magnet; and

FIG. 5 is a schematic view showing the relationship between a volume of a single-layer permanent magnet and the value of A/T of the motor rotor according to the present application, in which, A is the thickness of the tail end of the permanent magnet, and T is the thickness of the center of the permanent magnet.

### DETAILED DESCRIPTION

The present application is described in detail hereinafter in conjunction with drawings and embodiments.

A motor rotor according to the present application includes an iron core 10 and a permanent magnet 20 arranged inside the iron core 10. Multiple groups of mounting grooves 30 are arranged in the iron core 10 along the circumferential direction of the iron core 10, and each group of mounting grooves 30 includes two or more than two mounting grooves 30 arranged at intervals in the radial direction of the iron core 10. There are multiple groups of permanent magnets 20, and permanent magnets 20 in each group of permanent magnets 20 are correspondingly embedded into corresponding mounting grooves 30 in each group of mounting grooves 30. On a cross section, in a direction perpendicular to an axis of the rotor, of the permanent magnet 20, a center portion of the permanent magnet 20 has a thickness greater than two ends of the permanent magnet 20.

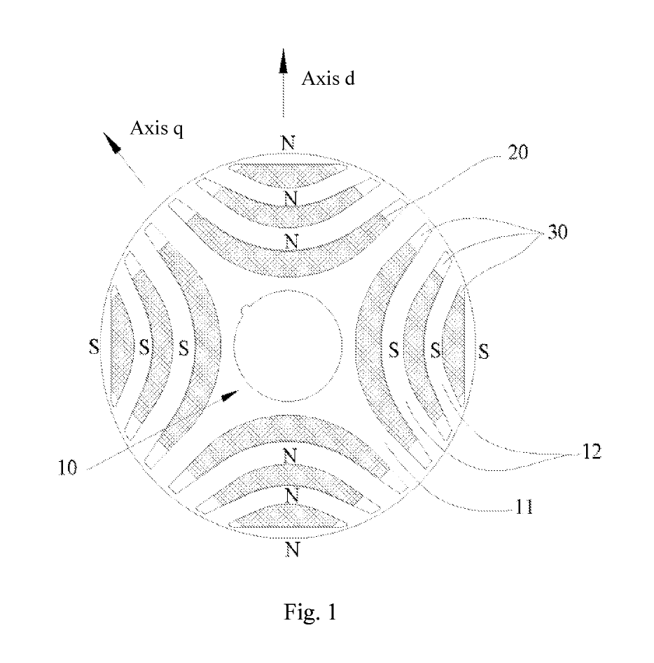

The quadrupole motor rotor with each pole having three layers of permanent magnets in FIG. 1 is described as an example, reference numeral 10 in FIG. 1 refers to an iron core of the motor rotor formed by laminated silicon steel sheets, four groups of through grooves are uniformly distributed in the circumferential direction taking the axes of the iron core 10 as a center, and each group of through grooves includes three layers of arc-shaped mounting grooves 30. When placing permanent magnets 20 into the mounting grooves 30, it requires that the permanent magnets 20 in the same group have the same polarity in a direction toward a periphery of the motor rotor, that is, all of the three layers of permanent magnets in FIG. 1 show N polarity in the direction of axis d; and at the same time, it also requires that two adjacent groups of permanent magnets show opposite polarities, thus the four groups of permanent magnets are distributed along the circumferential direction of the motor rotor to show N polarity and S polarity alternately. A magnetic flux path 12 with a certain width formed by silicon steel sheets is arranged between two adjacent layers of permanent magnets 20 in the same group of permanent magnets 20, and a connecting rib 11 with an inconstant width is arranged between two adjacent poles.

Since multiple layers of permanent magnets 20 are placed in the direction of axis d, and the permanent magnet 20 has a relatively high magnetic reluctance and has a magnetic permeability approximately equal to air, an inductance L_{d} in the direction of axis d is relatively low, however, in the direction of axis q, the iron core 10 has a relatively high magnetic permeability, thus an inductance L_{q} in the direction of axis q is relatively high, thereby increasing the magnetic reluctance torque of the motor rotor, and in turn increasing the output torque of the motor and improving the efficiency of the motor.

In addition, the full utilization of the magnetic reluctance torque requires that both of the magnetic flux path 12 and the connecting rib 11 have a certain width, thus the permanent magnets 20 can be arranged in one pole of the rotor as many as possible when the middle portion of the arc-shaped permanent magnet has a thickness greater than two end thereof the permanent magnet, thereby increasing the occupation ratio of the permanent magnets 20 in each pole of the rotor. The increase of the permanent magnets 20 may greatly increase the permanent magnet torque, thereby improving the efficiency of the motor.

As shown in FIG. 1, there are clearances between two ends of each permanent magnet 20 and two ends of the mounting groove 30 in which the permanent magnet 20 is embedded. The clearances between the two ends of the permanent magnet 20 and the two ends of the mounting groove 30 are filled with non-magnetically permeable media.

Each group of permanent magnets 20 includes a permanent magnet 20 having an arc-shaped cross section in a direction perpendicular to the axis of the rotor, and a surface, close to the center of the rotor in the radial direction of the rotor, of each permanent magnet 20 in each group of permanent magnets 20 is of an arc shape. Since demagnetization tends to happen at two ends of the permanent magnet 20 having a thinner thickness, the permanent magnet 20 does not fill the entire mounting groove 30, and a certain space is provided at two ends of the permanent magnet 20 so as to prevent demagnetization at the ends of the permanent magnets 20. In this embodiment, since the arc-shaped permanent magnet 20 is slightly shorter than the mounting groove 30, there are clearances at both ends of the permanent magnet 20 after the permanent magnet 20 is inserted into the mounting groove 30, and air or other non-magnetically permeable media may be filled in the clearances.

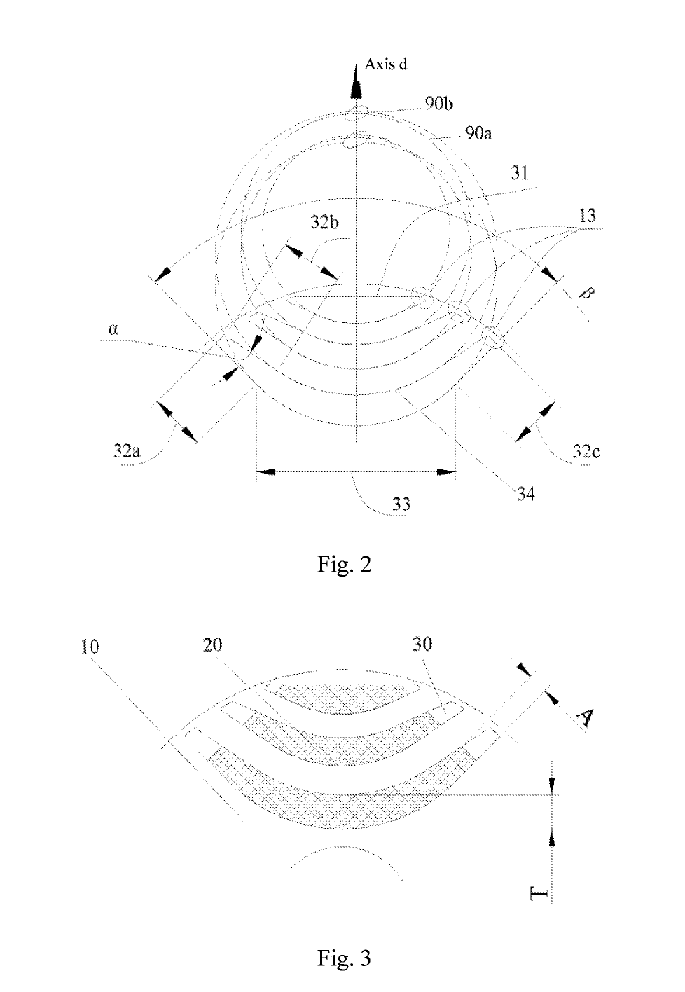

Preferably, as shown in FIG. 2, a magnetic shielding bridge 13 is formed between an edge of the mounting groove 30 and a periphery of the rotor, and a width of the magnetic shielding bridge 13 is ranged from 0.5 mm to 1.0 mm.

There is a distance between the mounting groove 30 and a periphery of the rotor, thus the magnetic shielding bridge 13 is formed at this position, so as to further reduce the magnetic flux leakage of the permanent magnet 20 at the edge of the permanent magnet 20, and improve the utilization ratio of the permanent magnetic flux. The width of the magnetic shielding bridge 13 should be within a certain range, the magnetic shielding effect may be affected if the magnetic shielding bridge 13 is too wide, and the whole mechanical strength of the rotor may be affected if the magnetic shielding bridge 13 is too narrow, therefore, optimum magnetic shielding effect may be obtained by arranging the width of the magnetic shielding bridge 13 in a range of 0.5 mm to 1.0 mm while ensuring the mechanical strength of the rotor.

As shown in FIG. 3, a thickness of the permanent magnet 20 in a direction along its symmetric line is T, and the thickness of the furthest end of the permanent magnet 20 is A, and wherein,

$$\frac{2}{5} \leq \frac{A}{T} \leq 1.$$

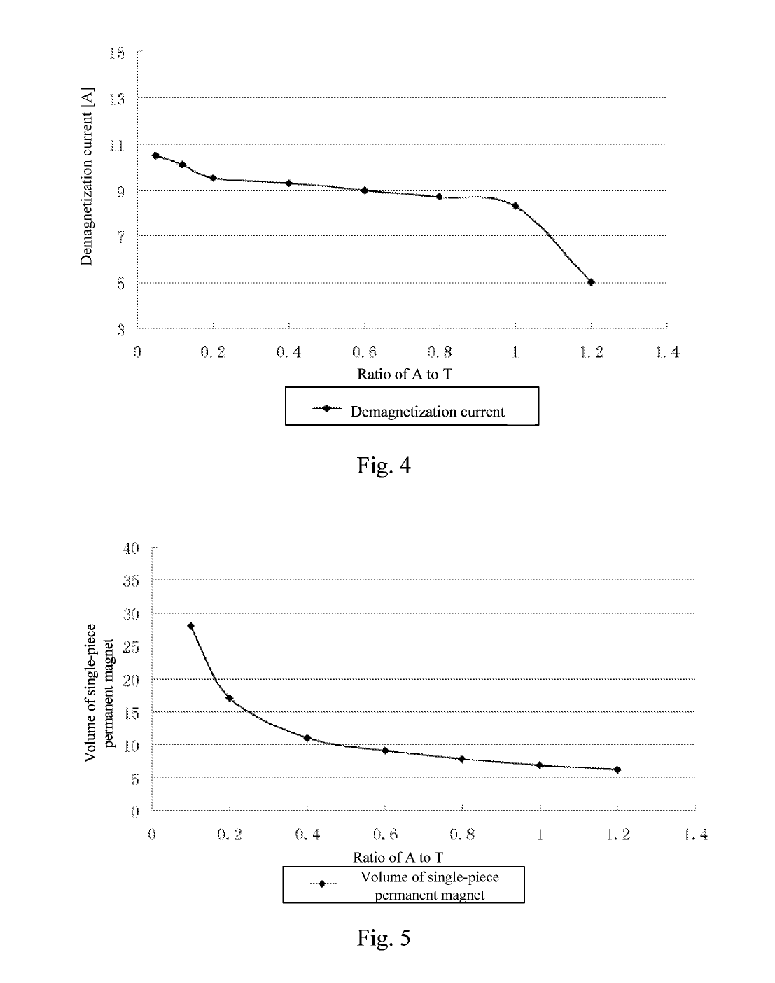

To avoid an irreversible demagnetization of the permanent magnet 20, and particularly the demagnetization at a central portion of the permanent magnet 20, the ratio of A to T is limited within the aforementioned range. As shown in FIGS. 4 and 5, FIG. 4 is a schematic view showing the relationship between a demagnetization current and the value of A/T of the motor rotor, and FIG. 5 is a schematic view showing the relationship between a volume of a single-layer permanent magnet and the value of A/T of the motor rotor, when the value of A/T is lower than 2/5, the volume of the used permanent magnet increases rapidly, however the corresponding demagnetization current does not increase significantly; and when the value of A/T is higher than 1, the arrangement of the permanent magnets in the rotor poles will be affected since a middle portion of the permanent magnet is thinner than two ends of the permanent magnet, which may reduce the occupation ratio of the permanent magnets. Therefore, the anti-demagnetization performance of the permanent magnets 20 may be improved by arranging the value of A/T in the above range, thereby allowing the motor to operate at a higher current and output greater torque. To facilitate research and calculation, the value of A in FIGS. 4 and 5 is constant, i.e. the thickness of both ends of the permanent magnet 20 is preset. The above formula regarding A/T is applicable to the relationship between the thickness of the end and the thickness of the center of any one of the permanent magnets 20 in the rotor.

As shown in FIG. 2, taking any group of mounting grooves 30 as an example, a cross section, perpendicular to the axial direction of the iron core 10, of the mounting groove 30 includes an outer arc segment 33, and a center of the outer arc segment 33 of the mounting groove 30 are distributed in the symmetry axis of the rotor. The cross section, perpendicular to the axial direction of the iron core 10, of the mounting groove 30 further includes an inner arc segment 34, and a center of the inner arc segment 34 of the mounting groove 30 are distributed in the symmetry axis of the rotor. Preferably, a cross section, perpendicular to the axial direction of the iron core 10, of each of the mounting grooves 30 includes an arc segment, and the centers of the arc segments, distributed sequentially in a direction from the axes to the periphery of the iron core 10, of each group of mounting grooves 30 are also distributed sequentially in this direction.

Reference numerals 90a and 90b in FIG. 2 refer to virtual circles in which the inner and outer arcs of each layer of mounting grooves 30 are located respectively, it can be seen that the centers of all the arcs are distributed in the direction of axis d, and are distributed in the symmetry axis of the mounting grooves. The centers of arcs, distributed outwards from the axes of the rotor, are away from the center of the rotor sequentially. The inner arcs of each layer of mounting grooves 30 are converged to an imaginary region 9b outside the rotor; correspondingly, the outer arcs are converged to an imaginary region 9a outside the rotor, and a distance between the two regions is related to the thickness of the permanent magnet 20.

Preferably, an inner arc of each of the outermost layer of the permanent magnets 20 and the outermost layer of mounting grooves 30 may be in an arc shape, but is generally arranged as a straight line segment 31 perpendicular to the direction of axis d so as to increase the usage of permanent magnets 20 at the outer layer, thereby increasing the magnetic field strength at the surface of the rotor.

As shown in FIG. 2, the cross section, perpendicular to the axial direction of the iron core 10, of the mounting groove 30 further includes a first outer straight line segment 32a and a second outer straight line segment 32c which are respectively connected to two ends of the outer arc segment 33, and an angle β is formed between the first outer straight line segment 32a and the second outer straight line segment 32c, and satisfies a relational expression of

$$\frac{3 π}{P} > β > \frac{4 π}{3 P} ,$$

wherein P is a number of rotor poles of the motor rotor.

The inner layer of grooves closest to the rotor center in FIG. 2 is described as an example The first outer straight line segment 32a and the second outer straight line segment 32c are respectively connected to two ends of the outer arc segment 33 and are respectively extended to a position having a distance of 0.5 mm to 1.0 mm to the periphery of the rotor. The angle β is formed between the first outer straight line segment 32a and the second outer straight line segment 32c. More permanent magnets may be placed in each pole when β meets the above relational expression.

As shown in FIG. 2, the cross section, perpendicular to the axial direction of the iron core 10, of the mounting groove 30 further includes a first outer straight line segment 32a connected to an end of the outer arc segment 33, and a first inner straight line segment 32b connected to an end of the inner arc segment 34 and positioned at the same side as the first outer straight line segment 32a, and an angle α is formed between the first outer straight line segment 32a and the first inner straight line segment 32b, wherein a is an acute angle.

The acute angle α is formed between the first outer straight line segment 32a and the first inner straight line segment 32b at the tail end of the mounting groove 30, thus the mounting groove 30 has a convergence effect at the extending portion of the tail ends thereof, and the width of the center, along the axis d, of the mounting groove 30 is greater than the width of two ends of the mounting groove 30. Since the shape of the permanent magnet 20 is designed to closely abut against the mounting groove 30, the purpose of fixing the permanent magnets 20 and preventing the permanent magnets 20 from sliding when the rotor rotates may be realized without using any additional fixing means or adhesive through such convergence effect. This arrangement is also applicable to the configuration of inner and outer edges of grooves in other shapes.

The present application further provides a motor including the above motor rotor.

In the motor provided by the present application, the utilization of the reluctance torque is increased and the efficiency of the motor is improved by defining the relationship between the thickness of the permanent magnets and the distance between the permanent magnets. The motor provided by the present application may be used in air condition compressors, electric vehicles, and fan systems.

As can be seen from the above description, the embodiments of the present application may achieve the following technical effects.

By studying the relationship between the thicknesses at the center and two ends of the permanent magnets placed in the mounting grooves of the motor rotor and the design of the permanent magnets and the mounting grooves, the motor rotor and the motor having the same provided by the present application provide a method for increasing the occupation ratio of the permanent magnets and improving the anti-demagnetization performance of the permanent magnets of the motor rotor without affecting the utilization of the magnetic reluctance torque, which optimizes the shape of the permanent magnet, and improves the efficiency of the motor and achieves the effect that the motor can operate at higher load conditions without a tendency of occurring demagnetization.

The embodiments described hereinabove are only preferred embodiments of the present application, and should not be interpreted as limitation to the present application. For the persons skilled in the art, various variations and modifications may be made to the present application. Any modifications, equivalent replacements and improvements made within the spirit and principle of the present application are also deemed to fall into the protection scope of the present application.

1. A motor rotor, comprising an iron core and a permanent magnet arranged inside the iron core, wherein,
a plurality of groups of mounting grooves are arranged in the iron core along a circumferential direction of the iron core, and each group of mounting grooves comprises two or more than two mounting grooves arranged at intervals in a radial direction of the iron core;
a plurality of groups of permanent magnets are provided, and permanent magnets in each group of permanent magnets are correspondingly embedded into corresponding mounting grooves in each group of mounting grooves; and
on a cross section, in a direction perpendicular to an axis of the rotor, of each permanent magnet, a center portion of the permanent magnet has a thickness greater than that of two ends of the permanent magnet.

2. The motor rotor according to claim 1, wherein a thickness of the permanent magnet in a direction along its symmetric line is T, and a thickness of the furthest end of the permanent magnet is A, and wherein,
$$\frac{2}{5} \leq \frac{A}{T} \leq 1.$$

3. The motor rotor according to claim 1, wherein a magnetic shielding bridge is formed between an edge of each mounting groove and a periphery of the rotor, and a width of the magnetic shielding bridge is ranged from 0.5 mm to 1.0 mm.

4. The motor rotor according to claim 1, wherein a cross section, perpendicular to an axial direction of the iron core, of each mounting groove comprises an outer arc segment, and a center of the outer arc segment of the mounting grooves are distributed in a symmetry axis of the rotor.

5. The motor rotor according to claim 4, wherein the cross section, perpendicular to the axial direction of the iron core, of the mounting groove further comprises an inner arc segment, and a center of the inner arc segment of the mounting groove are distributed in the symmetry axis of the rotor.

6. The motor rotor according to claim 5, wherein the cross section, perpendicular to the axial direction of the iron core, of the mounting groove further comprises a first outer straight line segment and a second outer straight line segment which are respectively connected to two ends of the outer arc segment, and an angle β is formed between the first outer straight line segment and the second outer straight line segment, and the angle β satisfies a relational expression of
$$\frac{3 π}{P} > β > \frac{4 π}{3 P} ,$$
wherein P is a number of rotor poles of the motor rotor.

7. The motor rotor according to claim 5, wherein the cross section, perpendicular to the axial direction of the iron core, of the mounting groove further comprises a first outer straight line segment connected to an end of the outer arc segment, and a first inner straight line segment connected to an end of the inner arc segment and positioned at the same side as the first outer straight line segment, and an angle α is formed between the first outer straight line segment and the first inner straight line segment, wherein a is an acute angle.

8. The motor rotor according to claim 1, wherein a cross section, perpendicular to the axial direction of the iron core, of each of the mounting grooves comprises an arc segment, and centers of arc segments, distributed sequentially in a direction from an axes to a periphery of the iron core, of each group of mounting grooves are also distributed sequentially in this direction.

9. The motor rotor according to claim 1, wherein clearances are provided between two ends of each permanent magnet and two ends of the mounting groove in which the permanent magnet is embedded.

10. The motor rotor according to claim 9, wherein the clearances between the two ends of the permanent magnet and the two ends of the mounting groove are filled with non-magnetically permeable media.

11. A motor, comprising a motor rotor, wherein the motor rotor comprises an iron core and a permanent magnet arranged inside the iron core, and a plurality of groups of mounting grooves are arranged in the iron core along a circumferential direction of the iron core, and each group of mounting grooves comprises two or more than two mounting grooves arranged at intervals in a radial direction of the iron core; a plurality of groups of permanent magnets are provided, and permanent magnets in each group of permanent magnets are correspondingly embedded into corresponding mounting grooves in each group of mounting grooves; and on a cross section, in a direction perpendicular to an axis of the rotor, of each permanent magnet, a center portion of the permanent magnet has a thickness greater than that of two ends of the permanent magnet.

12. The motor rotor according to claim 2, wherein clearances are provided between two ends of each permanent magnet and two ends of the mounting groove in which the permanent magnet is embedded.

13. The motor rotor according to claim 3, wherein clearances are provided between two ends of each permanent magnet and two ends of the mounting groove in which the permanent magnet is embedded.

14. The motor rotor according to claim 4, wherein clearances are provided between two ends of each permanent magnet and two ends of the mounting groove in which the permanent magnet is embedded.

15. The motor rotor according to claim 5, wherein clearances are provided between two ends of each permanent magnet and two ends of the mounting groove in which the permanent magnet is embedded.

16. The motor rotor according to claim 6, wherein clearances are provided between two ends of each permanent magnet and two ends of the mounting groove in which the permanent magnet is embedded.

17. The motor rotor according to claim 7, wherein clearances are provided between two ends of each permanent magnet and two ends of the mounting groove in which the permanent magnet is embedded.

18. The motor rotor according to claim 8, wherein clearances are provided between two ends of each permanent magnet and two ends of the mounting groove in which the permanent magnet is embedded.
